(19) United States
(12) Patent Application Publication
(10) Pub. No.: US 2024/0300078 A1
(43) Pub. Date: Sep. 12, 2024

(54) DRIVING TOOL

(71) Applicant: MAKITA CORPORATION, Anjo-shi (JP)

(72) Inventors: Kiyonobu YOSHIKANE, Anjo-shi (JP); Makito TERAMOTO, Anjo-shi (JP)

(73) Assignee: MAKITA CORPORATION, Anjo-shi (JP)

(21) Appl. No.: 18/591,018

(22) Filed: Feb. 29, 2024

(30) Foreign Application Priority Data
Mar. 7, 2023 (JP) 2023-034480
Dec. 27, 2023 (JP) 2023-220726

(51) Int. Cl. B25C 1/00; B25C 5/16

(52) U.S. Cl. CPC B25C 1/008; B25C 5/1617

(57) ABSTRACT

A driving tool has a tool body with a driving channel. A magazine is attached to the tool body. A pusher biases driven members inside the magazine toward the driving channel. The driver strikes one of the driven members fed in the driving channel. A blank drive preventing mechanism restricts a driving operation of the driver when a number of driven members inside the magazine is less than or equal to a predetermined number. The resistance-applying member applies resistance to the driven members remaining inside the magazine when the blank drive preventing mechanism is actuated and maintains the orientation of the driven members. The resistance-applying member is provided at a location corresponding to the shortest available driven member.

### CROSS-REFERENCE TO RELATED APPLICATIONS

This application claims priority to Japanese patent application serial numbers 2023-034480 filed Mar. 7, 2023 and 2023-220726 filed Dec. 27, 2023 the contents of which are incorporated herein by reference in their entirety for all purposes.

### BACKGROUND

The present disclosure relates to a driving tool for driving driven members such as nails and staples to wood etc.

Existing prior art discloses a pneumatic driving tool configured to unload a driven member using gas pressure of supplied compressed air as driving force. A driver that strikes a driven member is connected to a piston that is movable within a cylinder. Compressed air is supplied to an upper chamber of the piston. The gas pressure of the compressed air is used to move the driver downward together with the piston. The driven member struck by the driver is ejected from an ejection port and driven into a workpiece. Another disclosure reveals a driving tool in which rotational drive of an electric motor is converted into linear motion of the driver, and the driver ejects driven members.

The driving tool is provided with a magazine to accommodate driven members. The driven members are successively fed from the magazine into a driving channel where the driver moves, each time a driving operation is performed. When the number of driven members remaining in the magazine is less than or equal to a predetermined number, for example, zero, the driven members are no longer fed to the driving channel. If the driver moves downward through the driving channel even if the number of driven members is zero, the driver will be in a blank driving mode in which the driver drives the workpiece directly, resulting in damage to the workpiece. In addition, the piston collides with a cushion designed to dampen a downward momentum of the piston with a maximum load. This shortens a life span of the cushion. As described in the above documents, a driving tool has been conventionally invented having a blank drive preventing mechanism that prevents blank driving of the driver when the number of driven members in the magazine is less than or equal to a predetermined number.

When the blank drive preventing mechanism operates, a predetermined number of driven members remain in the magazine. This allows last driven member to continue to receive pressure toward the driving channel through the remaining driven members in the magazine. This allows for stabilizing the orientation of the driven members loaded into the driving channel, thereby preventing nail jams.

Next set of driven members is loaded into the magazine while the driven members remain in the magazine. The remaining driven members may be connected, for example, in its thickness direction. To make effective use of a space in the magazine, it is preferable to have a small number of remaining driven members when the blank drive preventing mechanism is operated. However, driven members that are interconnected by a small number of pieces have a thin total thickness. Therefore, for example, when the next set of driven members is loaded with the magazine opening being oriented upward, the remaining driven members may collapse within the magazine. Thus, the workability during the loading of driven members may be reduced.

Therefore, there has been a need for a driving tool that can prevent the collapse of driven members that remain inside the magazine when new set of the driven members is loaded in the magazine.

### SUMMARY

A driving tool according to one aspect of the present disclosure includes a tool body with a driving channel. The driving tool has a magazine that is attached to the tool body. The driving tool has a pusher that biases driven members within the magazine toward the driving channel. The driving tool has a driver to drive a driven member fed into the driving channel. The driving tool has a blank drive preventing mechanism that restricts a driving operation of the driver when a number of driven members inside the magazine is less than or equal to a predetermined number. The driving tool has a resistance-applying member that maintains orientation of remaining driven members in the magazine by applying resistance to the remaining driven members when the blank drive preventing mechanism is operated. The resistance-applying member is provided at a location corresponding to a shortest available driven member.

Therefore, when the blank drive preventing mechanism operates, a predetermined number of driven members remain inside the magazine. When the magazine is opened to load next driven members, the pusher that biases the remaining driven members toward the driving channel is released. Even in this case, the resistance-applying member may maintain the orientation of the remaining driven members in the magazine, thereby preventing the remaining driven members in the magazine from collapsing when the magazine is loaded with driven members. Moreover, by being able to suppress the collapse of the shortest available driven member, it is also possible to suppress the collapse of available driven members with various lengths.

### BRIEF DESCRIPTION OF THE DRAWINGS

FIG. 1 is a right side view of a driving tool according to a first example of the present disclosure.

FIG. 2 is a left side view of the driving tool.

FIG. 3 is a vertical cross-sectional view of the driving tool with a driver in a stand-by position.

FIG. 4 is a cross-sectional view taken along line IV-IV in FIG. 3.

FIG. 5 is across-sectional view corresponds to the cross-sectional view taken along line IV-IV in FIG. 3 and shows a state in which a blank drive preventing mechanism is turned on.

FIG. 6 is a partial perspective view of the driver, a lift mechanism, and a magazine.

FIG. 7 is a left side view of the blank drive preventing mechanism and a contact arm.

FIG. 8 is a perspective view of the magazine with driven members loaded therein.

FIG. 9 is a perspective view of a resistance-applying member and driven members.

FIG. 10 is a perspective view of a resistance-applying member of the driving tool and driven members according to a second example.

FIG. 11 is a front view of a resistance-applying member and the magazine of the driving tool according to a third example.

FIG. 12 is a perspective view of the resistance-applying member.

FIG. 13 is a front side view of the resistance-applying member.

FIG. 14 is a left side view of the resistance-applying member.

### DETAILED DESCRIPTION

According to one aspect of the present disclosure, the resistance-applying member may have an elastic member configured to bias driven members with elastic force. Therefore, by holding the driven members elastically by the elastic member, the orientation of the driven members remaining inside the magazine can be suppressed prevented from changing. Therefore, the remaining driven members may be held in a stable orientation within the magazine.

The elastic member according to another aspect of the present disclosure may be made of rubber. The rubber may be a material with a wide range of shape and elasticity. Therefore, the elastic member can be designed to have a suitable shape and elastic force, and the orientation of the driven members may be suitably maintained by the elastic member.

The resistance-applying member according to another aspect of the present disclosure may have a contacting part that contacts the driven members. The contacting part includes a loading-side curved surface in a loading direction of driven members into the magazine. Therefore, by providing the contacting part with the loading-side curved surface, the resistance-applying member can reduce resistance applied by the resistance-applying member to the driven members in the loading direction of driven members into the magazine. Therefore, the driven members can be smoothly loaded into the magazine.

The contacting part according to another aspect of the present disclosure may include a feed-side curved surface in a biasing direction of the pusher. Therefore, by providing the feed-side curved surface on the contacting part, the resistance-applying member may reduce resistance applied by the resistance-applying member to the driven members in the biasing direction of the pusher. Therefore, the pusher can bias the driven members smoothly toward the driving channel.

According to another aspect of the present disclosure, the contacting part may include an unloading-side curved surface in an unloading direction of driven members from the magazine. Therefore, by providing the unloading-side curved surface on the contacting part, the resistance-applying member can reduce resistance applied to the driven members in the unloading direction of driven members from the magazine. Therefore, for example, when remaining driven members are to be unloaded from the magazine, they can be easily unloaded.

According to another aspect of the present disclosure, the resistance-applying member may have a contacting part that contacts the driven members. The contacting part may include a flat contacting surface that contacts a side of a driven member in a surface contact manner. Therefore, the flat contacting surface contacts the side of the driven member in the surface contact manner, thereby preventing the contacting part from entering a groove between driven members arranged in parallel. This allows the pusher to smoothly feed the driven members.

According to another aspect of the present disclosure, the magazine may have an opening through which driven members are loaded from downstream to upstream in the driving direction of the driven member. Therefore, the user loads driven members into the magazine with the opening oriented substantially upward. Therefore, the driven members remaining in the magazine are in an orientation with bases facing a bottom of the magazine (downward) and legs facing a top of the magazine (upward). The resistance-applying member applies resistance to the driven members in this orientation to maintain the orientation of the driven members remaining in the magazine. This improves a workability of loading driven members into the magazine.

According to another aspect of the present disclosure, the blank drive preventing mechanism may have a detection member that is removed from the pusher when the number of driven members biased toward the pusher in the magazine is less than or equal to a predetermined number. The resistance-applying member biases the driven members in a direction parallel to the biasing direction of the detection member. Therefore, the biasing force acting from the detection member to the driven members or the pusher and the biasing force acting from the resistance-applying member to the driven members are applied from the same direction. Therefore, the driven members are prevented to be caught when the driven members and the pusher are fed toward the driving channel.

According to another aspect of the present disclosure, the blank drive preventing mechanism has a detection member that is removed from the pusher when the number of driven members biased toward the pusher in the magazine is less than or equal to a predetermined number. The detection member and the resistance-applying member are provided on the same side within the magazine. Therefore, the detection member and the resistance-applying member are located on the same side of the pusher and the driven members, respectively. Therefore, the detection member and the resistance-applying member can be compactly arranged within the magazine.

According to another aspect of the present disclosure, the resistance-applying member may have a holding part that is held in the magazine and a contacting part that is provided integrally with the holding part. The contacting part protrudes from the holding part, and contacts driven members. Therefore, the resistance-applying member can be provided with a simple structure in which the holding part and contacting part are formed in one piece.

According to another aspect of the present disclosure, the resistance-applying member may have a holding part that is held in the magazine. The resistance-applying member may have a deflection portion extending from the holding part and elastically deformable. The resistance-applying member may have a contacting part protruding from the deflection portion and contacting the driven member. The magazine has a supporting portion that supports the deflection portion with an end of the deflection portion contacting and the deflection portion bent. Therefore, the contacting part is always biased in a direction opposite to the biasing direction of the deflection portion. Moreover, the deflection portion can be retracted in a direction away from the driven members by being bent. The contacting part can thus always bias the driven members with a pushing load that does not cause the driven members to collapse in the magazine and enables them to be fed smoothly into the driving channel. In addition, the deflection portion is restricted by the supporting portion from protruding toward the driven members. This allows the pusher to smoothly feed the driven members.

According to another aspect of the present disclosure, the driven member may be a staple having a base that is struck by the driver and a pair of legs that extend substantially parallel from both ends of the base. Therefore, the staple with a long length in the width direction where the pair of legs are aligned can be held inside the magazine in a stable orientation by the resistance-applying member.

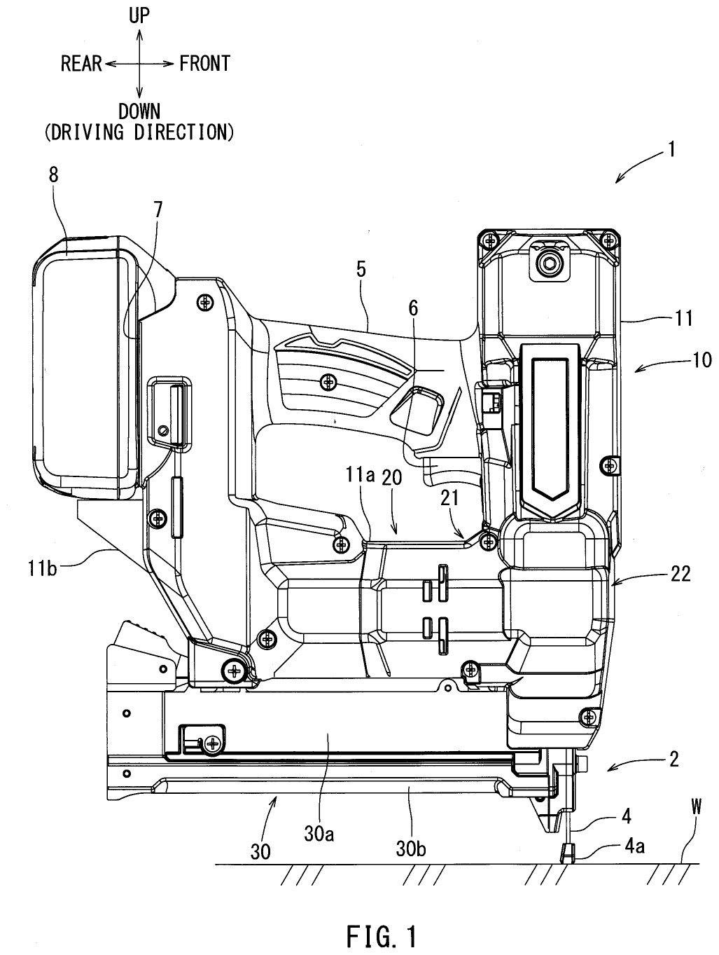

Hereinafter, one example of the present disclosure will be described with reference to FIGS. 1 to 10. As one example of a driving tool 1, a gas-spring type driving tool is shown that uses the gas pressure in a pressure accumulation chamber as a driving force for driving the driven member. In the following description, the driving direction of the driven member is a downward direction, and the counter-driving direction is an upward direction. The user of the driving tool 1 is typically located on the left side of the driving tool 1 in FIG. 1. The user's side is a rearward direction and the direction away from the user is a frontward direction. The left-right direction refers to the user.

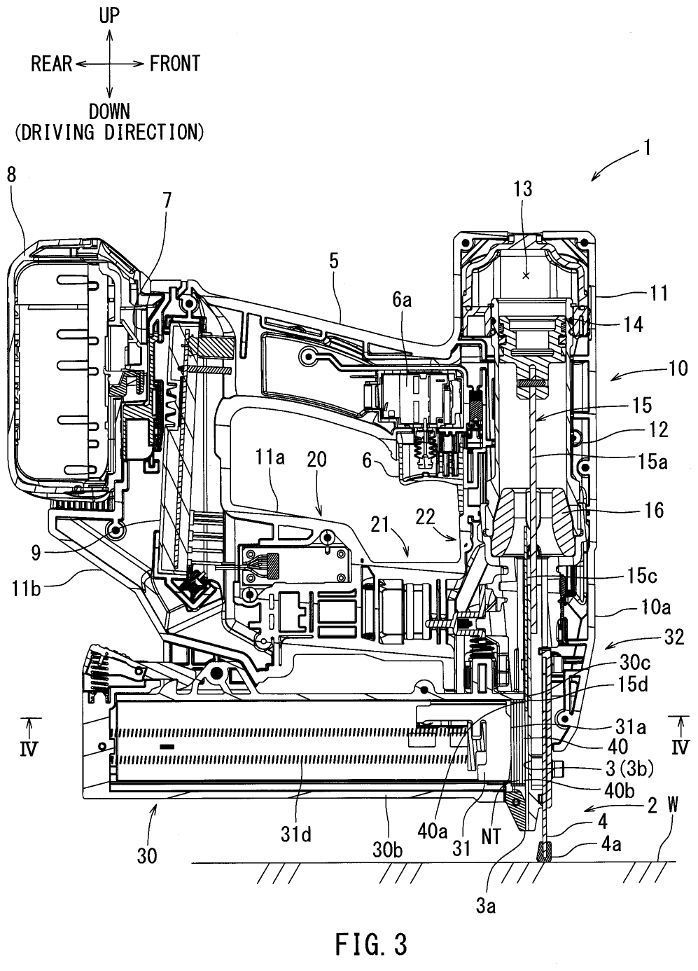

As shown in FIGS. 1 and 3, a driving tool 1 has a tool body 10. The tool body 10 has a cylindrical body housing 11 that generally houses a cylinder 12. A piston 14 is housed within the cylinder 12 so as to be reciprocally movable in an up-down direction. An upper portion of the cylinder 12, located above the piston 14, is communicates a pressure accumulation chamber 13. The pressure accumulation chamber 13 is filled with compressed gas, such as air. The gas pressure in the pressure accumulation chamber 13 acts as a driving force that biases an upper surface of the piston 14 to move downward.

As shown in FIG. 3, a lower part of the tool body 10 is provided with a driving nose 2 having a driving channel 3. The driving channel 3 extends in the up-down direction along a first end face 10a, which corresponds to a front face of the tool body 10. The driving channel 3 is connected to a lower part of the cylinder 12. The driving nose 2 is coupled with a magazine 30 in which driven members 40 are loaded. The magazine 30 may accommodate a plurality of driven members 40 extending in the up-down direction and arranged in parallel each other in a front-rear direction. The plurality of driven members 40 are bonded to each other while being aligned in the front-rear direction. The driven members 40 are fed forward one by one from inside the magazine 30 toward the driving channel 3.

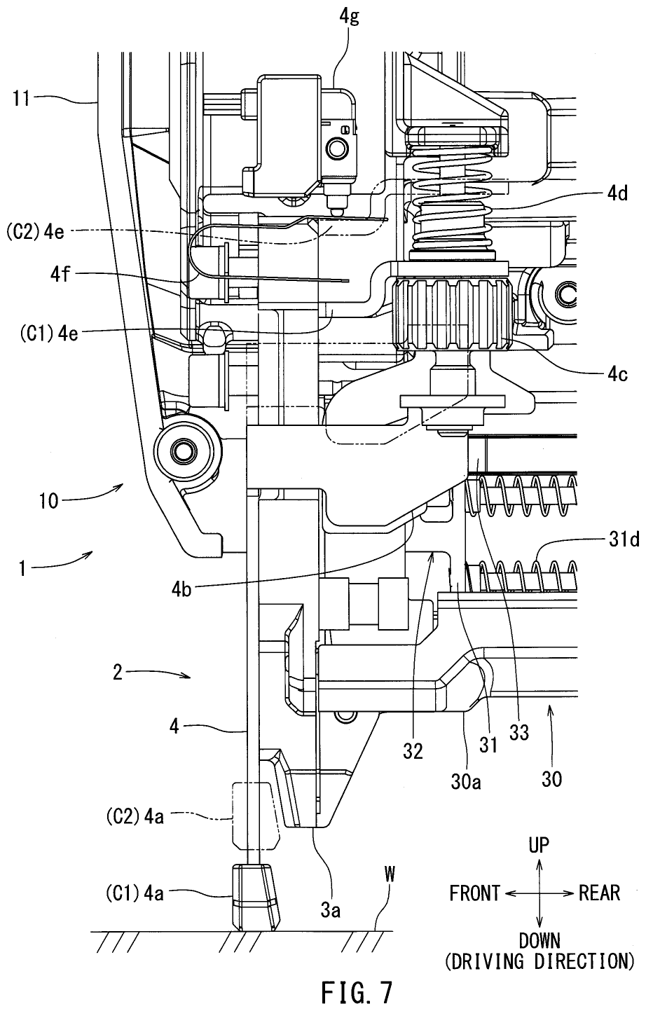

As shown in FIGS. 1 and 7, the driving nose 2 is provided with a contact arm 4 that can slide up and down. The contact arm 4 is biased toward a lower OFF position C1. The contact arm 4 moves from the OFF position upward to an ON position C2 against the biasing force when it contacts a workpiece W.

As shown in FIGS. 1 and 3, a grip 5 is provided at a rear of the tool body 10 for a user to grasp. On a front underside of the grip 5, a trigger 6 is provided to allow the user to operate by pulling it with his/her fingertip. A trigger switch 6a is provided inside the grip 5, which switches from an OFF state to an ON state in response to the pulling operation of the trigger 6. When the contact arm 4 is pressed against the workpiece and moves to the ON position C2 (FIG. 7), the pulling operation of the trigger 6 is enabled.

As shown in FIG. 3, a battery mounting section 7 extending in the up-down direction is provided on a rear side of the grip 5. A battery pack 8 can be removably attached to the battery mounting section 7. The battery pack 8 can be removed from the battery mounting section 7 and repeatedly recharged with a separately prepared charger. The battery pack 8 may also be used as a power source for other power tools. The battery pack 8 operates as a power source to supply power to an electric motor 20 or the like, which will be described below.

As shown in FIGS. 1 and 3, the main housing 11 has a drive unit case 11a and a connecting portion 11b. The drive unit case 11a has a substantially cylindrical shape and extends in the front-rear direction above the magazine 30. The connecting portion 11b extends upwards from a rear end of the drive unit case 11a. The grip 5, battery mounting section 7, connecting portion 11b, and drive unit case 11a cooperate to form a loop shape. The connecting portion 11b is provided with a controller 9 housed in a shallow-bottomed rectangular box-shaped case. The controller 9 is housed in the connecting portion 11b so as to extend substantially in the up-down direction. The controller 9 primarily controls the drive of the electric motor 20.

As shown in FIG. 3, a vertically long driver 15 is connected to an underside of the piston 14. The driver 15 has a body 15a connected to the piston 14 and a striking portion 15c connected to a lower portion of the body 15a. The striking portion 15c extends in the up-down direction behind the body 15a and parallel to the body 15a. More specifically, the driver 15 is provided in a front/rear two-stage structure with the body 15a and the striking portion 15c. A lower part of the striking portion 15c enters the driving channel 3. The driver 15 moves downward by the gas pressure in the pressure accumulation chamber 13 acting on the upper surface of the piston 14. An end 15d located at a lower end of the striking portion 15c strikes one driven member 40 fed into the driving channel 3 when it moves to the driving position. The struck driven member 40 is ejected from an ejection port 3a, which opens at a lower end of the driving channel 3. The ejected driven member 40 is driven into the workpiece W. A cushion 16 is arranged in the lower part of the cylinder 12 to absorb the impact of the piston 14 at its bottom dead center.

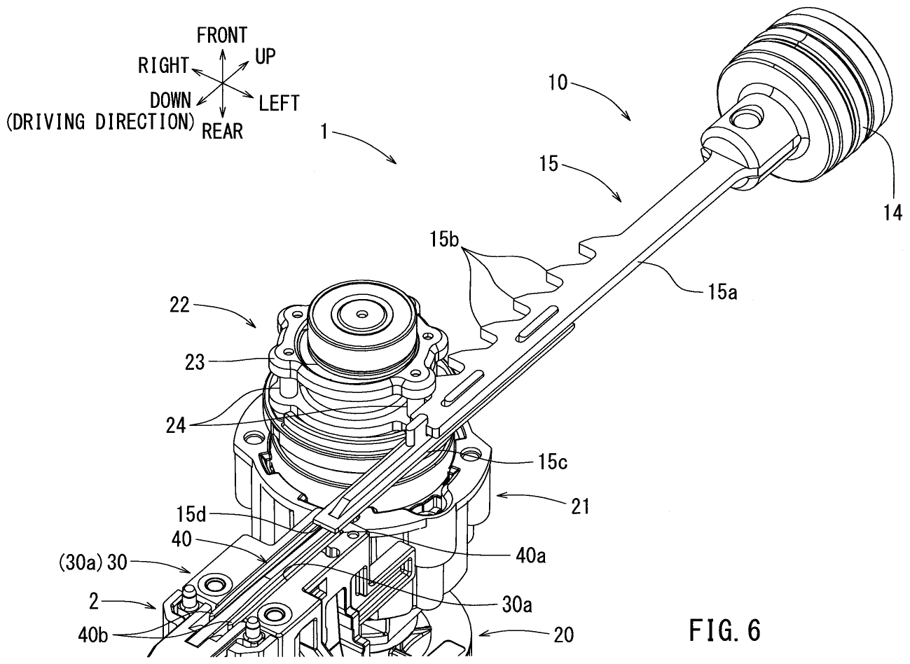

As shown in FIG. 6, a plurality of rack teeth (engaged portions) 15b protruding to right is provided on a right side of the body 15a of the driver 15. In this embodiment, six rack teeth 15b are aligned in a longitudinal (up-down) direction of the body 15a. Each rack tooth 15b is provided in a substantially triangular shape with its bottom portion oriented toward the driving direction (downward). The bottom portion of the rack teeth 15b engages with engaging portions 24 of the lift mechanism 22, which will be described below.

As shown in FIGS. 1 and 3, the drive unit case 11a houses an electric motor 20 as a drive source. The electric motor 20 is housed with a motor axis extending in the front-rear direction. The electric motor 20 is actuated by pulling the trigger 6 using an electric power of the battery pack 8 as a power source. A planetary reduction gear mechanism 21 is provided in front of the electric motor 20. Three rows of planetary gear are used in the planetary reduction gear mechanism 21. A lift mechanism 22 is provided in front of the planetary reduction gear mechanism 21 to move the driver 15 upward. The electric motor 20, the planetary reduction gear mechanism 21, and the lift mechanism 22 are aligned on the motor axis. The rotational drive of the electric motor 20 is slowed down by the planetary reduction gear mechanism 21 and transmitted to the lift mechanism 22.

As shown in FIGS. 1 and 6, the lift mechanism 22 is provided on a right side of the driving nose 2. The lift mechanism 22 has a wheel 23 that can rotate around a rotary shaft extending in the front-rear direction. The wheel 23 is rotatable in a counterclockwise direction as viewing from front and is restricted to rotate in a clockwise direction. A plurality of engaging portions 24 is arranged along an outer circumferential edge of the wheel 23. In this embodiment, for example, six engaging portions 24 may be provided. Cylindrical member (pin) extending in the front-rear directions may be used for the engaging portion 24. A left part of the wheel 23 enters the driving channel 3 through a window on the right side of the channel 3. Each engaging portion 24 of the wheel 23 engages with the bottom portion of the rack teeth 15b of the driver 15 in the driving channel 3. With at least one of the engaging portions 24 engaged with the bottom portion of the rack tooth 15b, the wheel 23 rotates in the counterclockwise direction. This causes the driver 15 and piston 14 to return upward. As the piston 14 is returned upward by the lift mechanism 22, the gas pressure in the pressure accumulation chamber 13 (FIG. 3) is increased.

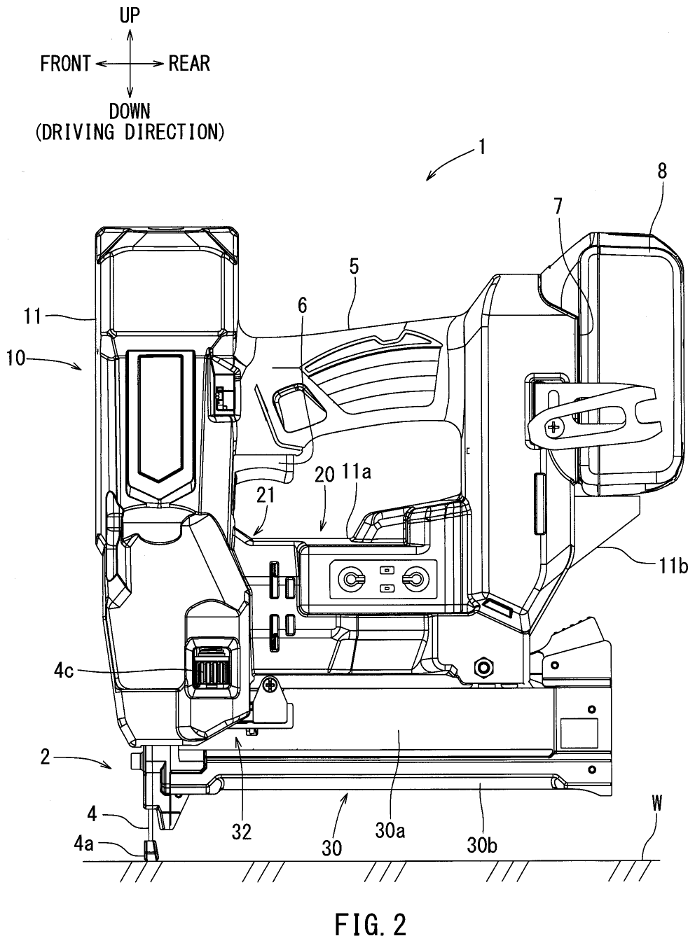

As shown in FIGS. 2, 4 and 7, the contact arm 4 is a plate-like member extending generally in an up-down direction. An end 4a located at a lower end of the contact arm 4 contacts the workpiece W. The contact arm 4 has an engaged portion 4b that engages a stopper 33 described below on a left side of the magazine 30. The engaged portion 4b is provided in a form of a U-shaped groove as viewing in the left-right direction with openings oriented toward rear and right. The stopper 33 engages an underside of the engaged portion 4b (front side in figures), which is not visible in the figures. The contact arm 4 is connected to an adjustment dial 4c above the engaged portion 4b. By rotating the adjustment dial 4c, a length of protrusion of the end 4a of the contact arm 4 in the up-down direction can be adjusted.

As shown in FIG. 7, the contact arm 4 has a switch contacting part 4e that extends in the front-rear direction above the adjustment dial 4c. The contact arm 4 is biased downward by a compression spring 4d above the switch contacting part 4e. A push-operable switch 4g is provided above an end of the switch contacting part 4e. Between the switch contacting part 4e and the switch 4g, a leaf spring 4f is provided. When the end 4a of the contact arm 4 is pressed against the workpiece W, the contact arm 4 moves from the OFF position C1 to the ON position C2 against biasing force of the compression spring 4d. The switch contacting part 4e similarly moves from the OFF position C1 to the ON position C2 and presses the switch 4g via a leaf spring 4f. When switch 4g is pressed and in the ON state, pulling operation of the trigger 6 (see FIG. 2) is enabled. When the switch 4g is in the OFF state in which the switch 4g is not pressed, the pulling operation of the trigger 6 is not enabled.

As shown in FIGS. 1, 3, and 4, the magazine 30 is provided in a substantially rectangular box shape extending rearward from the driving nose 2. The magazine 30 has a magazine body 30a that can accommodate a plurality of driven members 40 and a cover 30b configured to cover a lower part of the magazine body 30a. A supply port 30c is provided at a front of the magazine 30, which opens toward the driving channel 3 in front and is connected to the driving channel 3. The magazine 30 is provided with a groove-shaped driven member housing section 30d extending in a straight line rearward from the supply port 30c. A plurality of driven members 40 and a pusher 31 that biases the driven members 40 forward toward the driving channel 3 are housed inside the driven member housing section 30d.

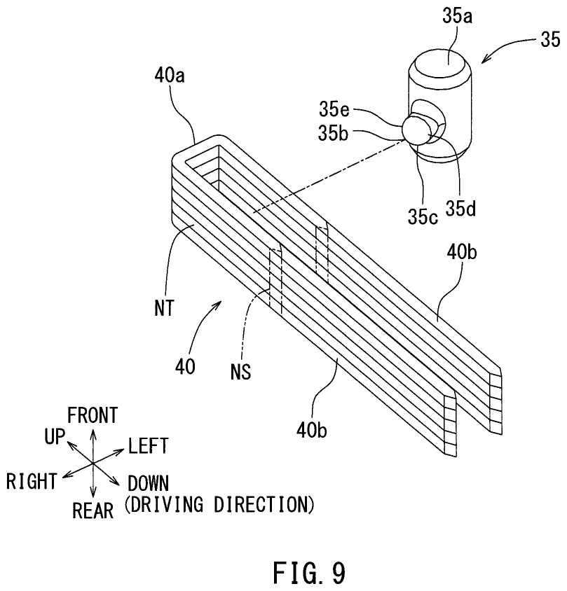

As shown in FIGS. 6 and 9, the driven member 40 is a U-shaped staple. Each driven member 40 has a rod-shaped base 40a extending in a left-right direction and a pair of legs 40b extending in a direction orthogonal to the base 40a from both ends of the base 40a. The driven member 40 is housed in the magazine 30 with the base 40a positioned above and the pair of legs 40b extending downward from the base 40a.

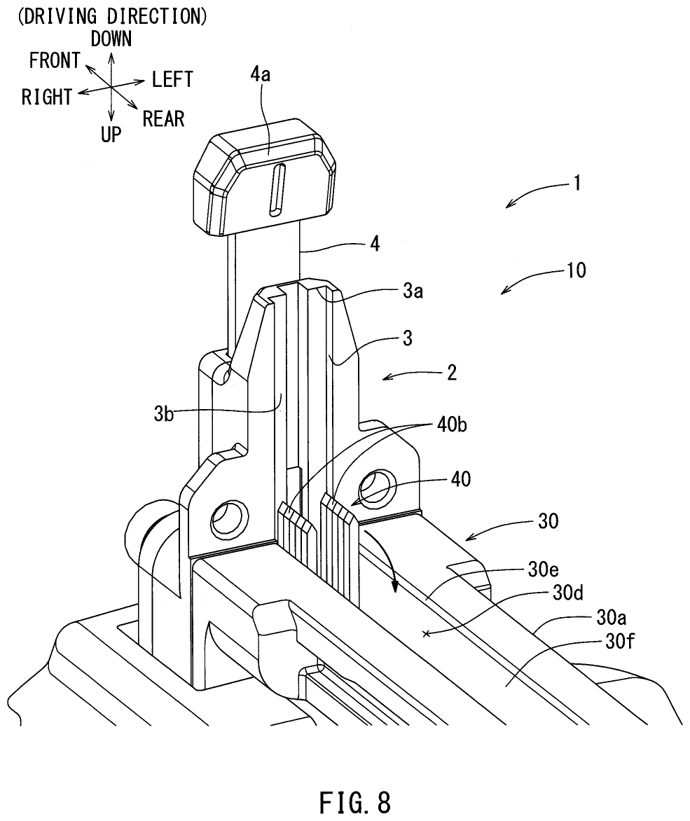

As shown in FIG. 8, an opening 30e extending in a straight line in the front-rear direction is provided in a lower side of the magazine body 30a. On both left-right sides of the opening 30e, side walls 30f are provided that planarly extend in the front-rear and up-down directions. A back side (upper side) of the opening 30e is connected to the driven member housing section 30d. When loading the magazine body 30a with the driven members 40, the loading operation is performed with bottom side of the driven members 40 oriented to the top side (upward) and the opening 30e oriented to the top side. The driven members 40 are loaded from the top side to the bottom side through the opening 30e with the bases 40a (see FIG. 9) on the bottom side (top side of the driven members 40) and the legs 40b on the top side (bottom side of the driven members 40).

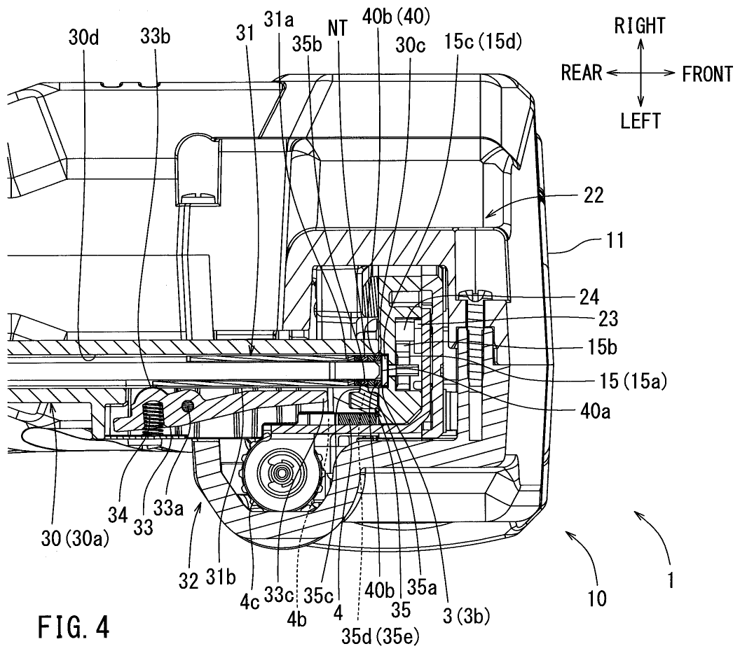

As shown in FIGS. 3 and 4, the pusher 31 has a pair of right and left flat plates extending in the up-down direction and the front-rear direction. The pusher 31 has a U-shape substantially the same as the driven member 40, as viewed from the front and rear directions. The pusher 31 is biased forward in the driven member housing section 30d by a compression spring 31d provided at rear of the pusher 31. A front side 31a of the pusher 31 biases the driven member 40 housed at a front toward the driving channel 3.

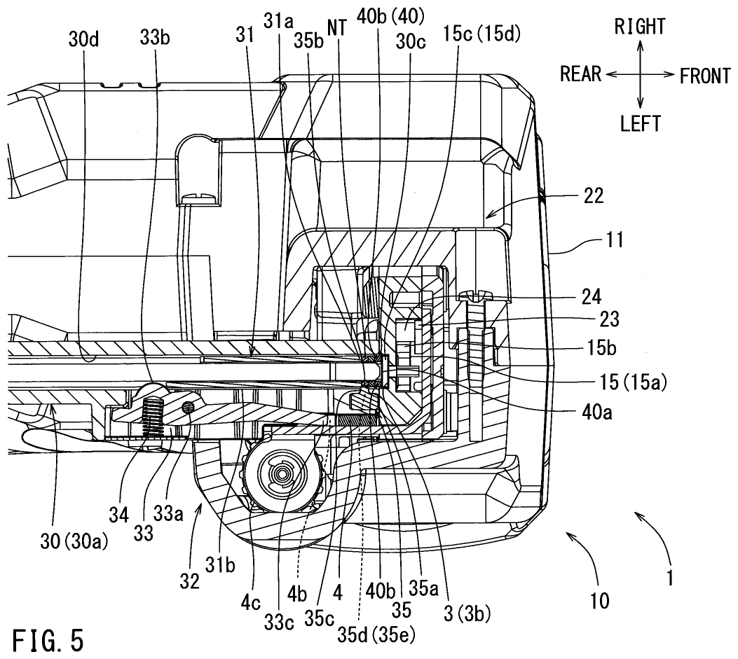

As shown in FIGS. 4 and 5, the driving tool 1 is provided with a blank drive preventing mechanism 32. The blank drive preventing mechanism 32 is operable when the number of driven members 40 remaining inside the magazine 30 is less than or equal to a predetermined number, and restricts the hoisting operation of the driver 15 by the lift mechanism 22. The blank drive preventing mechanism 32 of the present disclosure operates when there are three or fewer driven members 40 remaining inside the magazine 30. The blank drive preventing mechanism 32 is provided with a stopper (detection member) 33 that restricts upward movement of the contact arm 4. The stopper 33 is provided at a left side of the driven member housing section 30d of the magazine 30.

As shown in FIGS. 4 and 5, the stopper 33 extends in a generally straight line in the front-rear direction. The stopper 33 can rotate left-right direction around a rotary shaft 33a, which extends in an up-down direction. The rotary shaft 33a is provided slightly behind a center of the stopper 33 in the front-rear direction. An engaging portion 33c is provided at a front end of the stopper 33 that can engage the engaged portion 4b of the contact arm 4 located in the OFF position C1. When the engaging portion 33c engages the engaged portion 4b, the contact arm 4 is restricted from moving upward from the OFF position C1 to the ON position C2 (see FIG. 7). The stopper 33 has a contacting part 33b protruding to right behind the rotary shaft 33a. The contacting part 33b is provided in a semicircular shape as viewed in the up-down direction. The contacting part 33b can enter the driven member housing section 30d from the left side of the housing 30d.

As shown in FIGS. 4 and 5, a compression spring 34 is provided behind the rotary shaft 33a and to left of the contacting part 33b. The compression spring 34 biases the stopper 33 to rotate in a clockwise direction when viewed from below. The contacting part 33b of the stopper 33 is biased to right by the compression spring 34 so as to approach the pusher 31 in the driven member housing section 30d. The engaging portion 33c of the stopper 33 is biased to left by the compression spring 34 so as to be distanced from the pusher 31 within the driven member housing section 30d and approach the engaged portion 4b of the contact arm 4.

As shown in FIGS. 4 and 5, the magazine body 30a is provided with a resistance-applying member (e.g., elastic member) 35 that provide resistance to the driven members 40 that remain in the driven member housing section 30d. The resistance-applying member 35 is arranged on the left side of the driven member housing section 30d, aligned in front of the stopper 33. The resistance-applying member 35 has a holding part 35a that is held in the magazine body 30a and a contacting part 35b that protrudes from the holding part 35a and contacts the driven member(s) 40. The resistance-applying member 35 is held in the magazine body 30a with the holding part 35a positioned to left and the contacting part 35b positioned to right of the driven member 40. The contacting part 35b contacts the left side of the leg 40b of the driven member NT from left, located third counting from a front end of the supply port 30c.

As shown in FIG. 9, the resistance-applying member 35 is formed with the holding part 35a and the contacting part 35b made of the same material in one piece. The resistance-applying member 35 is made of rubber with high elasticity. Multiple types of driven members 40 with different lengths of leg 40b may be used for the driving tool 1 (see FIG. 1). The contacting part 35b is disposed at a vertical position where it can contact the leg 40b of the shortest driven member NS among the available driven members 40.

As shown in FIG. 9, the holding part 35a is provided in a substantially cylindrical shape with the front-rear direction as the axial direction. The contacting part 35b protrudes spherically (specifically, hemispherically) from a right side of the holding part 35a. The contacting part 35b contacts the leg 40b of the driven member NT at a right end with a spherical surface. The contacting part 35b provides resistance to the driven member NT in the front-rear and up-down directions. The spherical surface of contacting part 35b includes a feed-side curved surface 35c behind at a right end, a loading-side curved surface 35d below the right end, and an unloading-side curved surface 35e above the right end. The feed-side curved surface 35c is located upstream side of the contacting part 35b where the pusher 31 (see FIG. 4) biases the driven members 40. The loading-side curved surface 35d is located on a side of the contacting part 35b where the driven members 40 are loaded into the driven member housing section 30d (see FIG. 8). The unloading-side curved surface 35e is located on a side of the contacting part 35b where the driven members 40 are unloaded from the driven member housing section 30d (see FIG. 8).

As shown in FIG. 4, when four or more driven members 40 remain in the driven member housing section 30d, the contacting part 33b contacts a left side 31b of the pusher 31 or the leg 40b of the driven member 40. Therefore, the rotation of the stopper 33 is restricted and the engaging portion 33c is not engaged with the engaged portion 4b of the contact arm 4. The contact arm 4 can therefore move from the OFF position C1 to the ON position C2 (FIG. 7).

As shown in FIG. 5, when the number of the driven members 40 remaining in the driven member housing section 30d becomes three, the pusher 31 moves forward beyond the contacting part 33b. This allows the contacting part 33b to enter the driven member housing section 30d without contacting the side 31b of the pusher 31. The stopper 33 rotates while being biased by the compression spring 34. The engaging portion 33c shifts to left and engages the engaged portion 4b of the contact arm 4. The contact arm 4 is therefore restricted from moving from the OFF position C1 to the ON position C 2, and the switch 4g is not pressed by the switch contacting part 4e of the contact arm 4 (see FIG. 7). Therefore, the pulling operation of the trigger 6 is not enabled and the electric motor 20 does not start (see FIG. 1). Thus, it is possible to prevent blank driving of the driver 15 when three or less driven members 40 are remaining in the magazine 30.

As shown in FIG. 5, three driven members 40 remain in the driven member housing section 30d after the blank drive preventing mechanism 32 has been operated. The last driven member NT of the three driven members 40 comes into contact with the contacting part 35b of the resistance-applying member 35, thereby being prevented from moving in the front-rear and up-down directions. For example, when the driving tool 1 is set in the position shown in FIG. 8 and a new driven member 40 is filled, the remaining driven members 40 in the driven member housing section 30d stand with the legs 40b extending substantially vertically. If the resistance-applying member 35 were not provided, the driven members 40 remaining in the driven member housing section 30d would easily collapse in the direction indicated by the arrow shown in FIG. 4. The resistance-applying member 35 applies resistance to the driven members 40 remaining in the driven member housing section 30d, thereby preventing the driven members 40 from tipping over when new driven members 40 are filled.

Hereinafter, a sequence of driving operations of driving tool 1 will be described with reference to FIGS. 3 to 6. FIGS. 3 to 6 show the driver 15 in a standby state. The driver 15 in the standby state is held while being stopped at a stand-by position slightly below a top dead center. The foremost driven member 40 located at the supply port 30c, does not enter the driving channel 3 and is stopped at the front end of the supply port 30c.

In the standby state, the contact arm 4 moves upward and the trigger 6 is pulled to start the electric motor 20. When the electric motor 20 is started, the wheel 23 of the lift mechanism 22 rotates. The engaging portion 24, which is engaged with a bottom surface of the lowermost rack tooth 15b, causes the lowermost rack tooth 15b to move upward as the wheel 23 rotates. This causes the driver 15 to move upward from the stand-by position to the top dead center. When the driver 15 moves to the top dead center, the driven member 40 is biased by the pusher 31 and allowed to enter the driving channel 3. As a result, the one foremost driven member 40 is fed from the magazine 30 into the driving channel 3.

When the driver 15 reached the state just before driving at the top dead center, the engaging portion 24 is disengaged from the bottom of the lowermost rack tooth 15b. As a result, the driver 15 is biased by the gas pressure in the pressure accumulation chamber 13 that was applied to the piston 14 and moves downward. The striking portion 15c of the driver 15 moves downward in the driving channel 3 to the striking position, and an end 15d of the driver 15 strikes the base 40a of one driven member 40. When the driver 15 moves downward, all engaging portions 24 are retracted from the driving channel 3. Therefore, interference between the rack teeth 15b of the downwardly moving driver 15 and the engaging portions 24 is avoided to allow a smooth striking operation.

The wheel 23 continues to rotate while the driver 15 moves downward and after the driver 15 reaches the bottom dead center. When the wheel 23 rotates to a predetermined angle of rotation after the driver 15 has reached the bottom dead center, one of the engaging portions 24 engages with a bottom of the uppermost rack tooth 15b. This initiates a returning motion that moves the driver 15 upward in the counter-driving direction. When one of the engaging portions 24 engages with the bottom of the lowermost rack tooth 15b, the driver 15 returns to the stand-by position. For example, by appropriately controlling a time counting from a start of the electric motor 20, the electric motor 20 stops when the piston 14 has reached the stand-by position. As a result, the driver 15 is held in the stand-by position. The series of driving operations is completed as described above.

As described above, the driving tool 1 has a tool body 10 with a driving channel 3 as shown in FIGS. 4 and 5. The driving tool 1 has a magazine 30 attached to the tool body 10. The driving tool 1 has a pusher 31 that biases driven members 40 inside the magazine 30 toward the driving channel 3. The driving tool 1 has a driver 15 that strikes a driven member 40 fed into the driving channel 3. The driving tool 1 has a blank drive preventing mechanism 32 that restricts a driving operation of the driver 15 when a number of driven members 40 inside the magazine 30 is less than or equal to a predetermined number. The driving tool 1 has a resistance-applying member 35 that applies resistance to the driven members 40 remaining inside the magazine 30 when the blank drive preventing mechanism 32 is actuated to maintain orientation of the driven members 40. The resistance-applying member 35 is provided at a location corresponding to a shortest available driven member NS (see FIG. 9).

Therefore, when the blank drive preventing mechanism 32 operates, a predetermined number of driven members 40 remain inside the magazine 30. When the magazine 30 is opened to load next 40 driven members 40, the pressing force of the pusher 31 to bias the remaining driven members 40 toward the driving channel 3 is released. Even in this case, the resistance-applying member 35 can hold the orientation of the driven members 40 remaining in the magazine 30, thereby preventing the driven members 40 remaining inside the magazine 30 from collapsing when the magazine 30 is loaded with next driven members 40. Moreover, since the shortest available driven member NS may be prevented from collapsing, the available driven members 40 having various lengths may also be prevented from collapsing.

As shown in FIGS. 4, 5, and 9, the resistance-applying member 35 has an elastic member that elastically biases the driven member(s) 40. Therefore, by holding the driven member 40 elastically by the elastic member, the orientation of the driven member(s) 40 remaining inside the magazine 30 can be prevented from changing. Therefore, the remaining driven member(s) 40 may be held in a stable orientation inside the magazine 30.

As shown in FIG. 9, the resistance-applying member (elastic member) 35 is made of rubber. Rubber is a material with a wide range of shape and elasticity. Therefore, the resistance-applying member 35 can be designed to have a suitable shape and elasticity, and the orientation of the driven member(s) 40 may be favorably maintained by the resistance-applying member 35.

As shown in FIGS. 4, 5, and 9, the resistance-applying member 35 has a contacting part 35b that contacts the driven member(s) 40. The contacting part 35b includes a loading-side curved surface 35d in the loading direction of the driven member 40 into the magazine 30. Therefore, by providing the contacting part 35b with the loading-side curved surface 35d, the resistance-applying member 35 can reduce the resistance applied by the resistance-applying member 35 to the driven members 40 in the direction of loading the driven members 40 into the magazine 30. Therefore, the driven members 40 can be smoothly loaded into the magazine 30.

As shown in FIG. 9, the contacting part 35b includes a feed-side curved surface 35c in the biasing direction of pusher 31. Therefore, by providing the fee-side curved surface 35c on the contacting part 35b, it is possible to reduce a resistance applied by the resistance-applying member 35 to the driven member 40 in the biasing direction of the pusher 31. Therefore, the driven member 40 can be smoothly biased by the pusher 31 toward the driving channel 3.

As shown in FIG. 9, the contacting part 35b includes an unloading-side curved surface 35e in an unloading direction of the driven member 40 from the magazine 30 (see FIG. 8). Therefore, by providing the unloading-side curved surface 35e on contacting part 35b, it is possible to reduce a resistance applied by the resistance-applying member 35 to the driven member 40 in the unloading direction of the driven member 40 from the magazine 30. Therefore, for example, when remaining driven members 40 are to be unloaded from the magazine 30, they can be easily unloaded.

As shown in FIG. 8, the magazine 30 has an opening 30e through which the driven members 40 are loaded from downstream to upstream in the driving direction. A user loads driven members 40 into the magazine 30 with the opening 30e substantially oriented upward. Therefore, the driven members 40 remaining in the magazine 30 are in an orientation with a base 40a facing a bottom (downward) of the magazine 30 and legs 40b facing top (upward). The resistance-applying member 35 applies resistance to the driven members 40 in this orientation to maintain the orientation of the driven members 40 remaining in the magazine 30. This improves workability of loading driven members 40 into the magazine 30.

As shown in FIGS. 4 and 5, the blank drive preventing mechanism 32 has a stopper 33 (detection member) that is biased toward the pusher 31 and removed from the pusher 31 when the number of driven members 40 in the magazine 30 is less than or equal to the predetermined number. The resistance-applying member 35 biases the driven members 40 in a direction parallel to the biasing direction of the stopper 33. Therefore, the biasing force acting from the stopper 33 to the driven members 40 or the pusher 31 and the biasing force acting from the resistance-applying member 35 to the driven members 40 are applied from the same direction. This can reduce for the driven members 40 to be caught when the driven members 40 and the pusher 31 are fed toward the driving channel 3.

As shown in FIGS. 4 and 5, the blank drive preventing mechanism 32 has a stopper 33 (detection member) that is biased toward the pusher 31 and removed from the pusher 31 when the number of driven members 40 in the magazine 30 is less than or equal to the predetermined number. The stopper 33 and the resistance-applying member 35 are provided on the same left side within the magazine 30. Therefore, the stopper 33 and the resistance-applying member 35 are located on the same left side of the pusher 31 and the driven members 40, respectively. Therefore, the stopper 33 and the resistance-applying member 35 can be compactly arranged within the magazine 30.

As shown in FIGS. 4 and 5, the resistance-applying member 35 has a holding part 35a that is held in the magazine 30 and a contacting part 30b that is provided integrally with the holding part 35a. The contacting part 30b protrudes from the holding part 35a, and contacts the driven member(s) 40. Therefore, the resistance-applying member 35 can be provided with a simple structure in which the holding part 35a and contacting part 35b are formed in one piece.

As shown in FIG. 6, the driven member 40 is a staple having a base 40a that is struck by the driver 15 and a pair of legs 40b that extend substantially parallel from both ends of the base 40a. Therefore, a staple with a long length in the width direction where the pair of legs 40b are aligned can be held inside the magazine 30 in a stable orientation by the resistance-applying member 35.

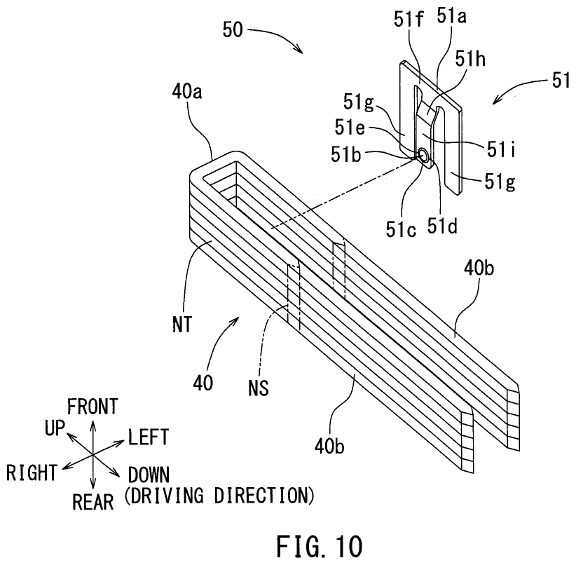

Hereinafter, a second example of the present disclosure will be described with reference to FIG. 10. The driving tool 50 of the second example has a resistance-applying member 51 (elastic member) 51 instead of the resistance-applying member 35 of the driving tool 1 shown in FIG. 4. In the following description, only the parts that differ from the first example will be described in detail.

As shown in FIG. 10, the resistance-applying member 51 is arranged on a left side of the driven member housing section 30d, aligned in front of the stopper 33 (see FIG. 4). The resistance-applying member 51 has a holding part 51a that is held in the magazine body 30a and a contacting part 51b that protrudes from the holding part 51a and contacts the driven member(s) 40. The resistance-applying member 51 is held in the magazine body 30a with the holding part 51a positioned to left and the contacting part 51b positioned to right of the driven member(s) 40. The contacting part 51b contacts the left side of the leg 40b of the driven member NT from left, located third counting from the front end of the supply port 30c.

As shown in FIG. 10, the resistance-applying member 51 is formed with the holding part 51a and the contacting part 51b made of the same material in one piece. The resistance-applying member 51 is formed in a plate shape made of metal with high elasticity. Multiple types of driven members 40 with different lengths of leg 40b may be used for the driving tool 1 (see FIG. 1). The contacting part 51b is disposed at a vertical position where it can contact the leg 40b of the shortest driven member NS among the available driven members 40.

As shown in FIG. 10, the holding part 51a is formed from a flat plate. A holding part 51a is U-shaped and has an upper side, a lower side, and a front side. The contacting part 51b is located on the inner circumference of the holding part 51a. The contacting part 51b is provided by notching a portion of a flat plate and projecting a portion to the right in form of spherical shape. The contacting part 51b contacts the leg 40b of the driven member NT at the right end with the curved surface. The contacting part 51b provides resistance to the driven member NT in the front-rear and up-down directions. The spherical surface of contacting part 51b includes a feed-side curved surface 51c behind the right end, a loading-side curved surface 51d below the right end, and an unloading-side curved surface 51e above the right end. The feed-side curved surface 51c is located upstream where the pusher 31 (see FIG. 4) biases the driven members 40 at the contacting part 51b. The loading-side curved surface 51d is located on the side where the driven members 40 are loaded into the driven member housing section 30d (FIG. 8) at contacting part 51b. The unloading-side curved surface 51e is located on the side where the driven members 40 are unloaded from the driven member housing section 30d at the contacting part 51b.

As shown in FIG. 10, the holding section 51a has a rectangular flat-shaped base 51f and a pair of legs 51g extending rearward from the upper and lower ends of the base 51f. By inserting the pair of legs 51g into a groove (not shown) in the magazine 30, the holding section 51a can be secured to the magazine 30. The holding part 51a has a bent portion 51h extending rearward from the base 51f and a rectangular flat-shaped flat portion 51i extending rearward from the bent portion 51h. The bent portion 51h and the flat portion 51i are provided between the pair of legs 51g in the up-down direction. The contacting part 51b is provided in the center of the flat portion 51i, which protrudes in the thickness direction of the flat portion 51i. The bent portion 51h is bent toward the protruding direction of the contacting part 51b. The flat portion 51i is therefore located on the side of the driven member 40 (right side) with respect to the base 51f. The bent portion 51h and the flat portion 51i may deflect to the left in the direction opposite to the protruding direction of the contacting part 51b.

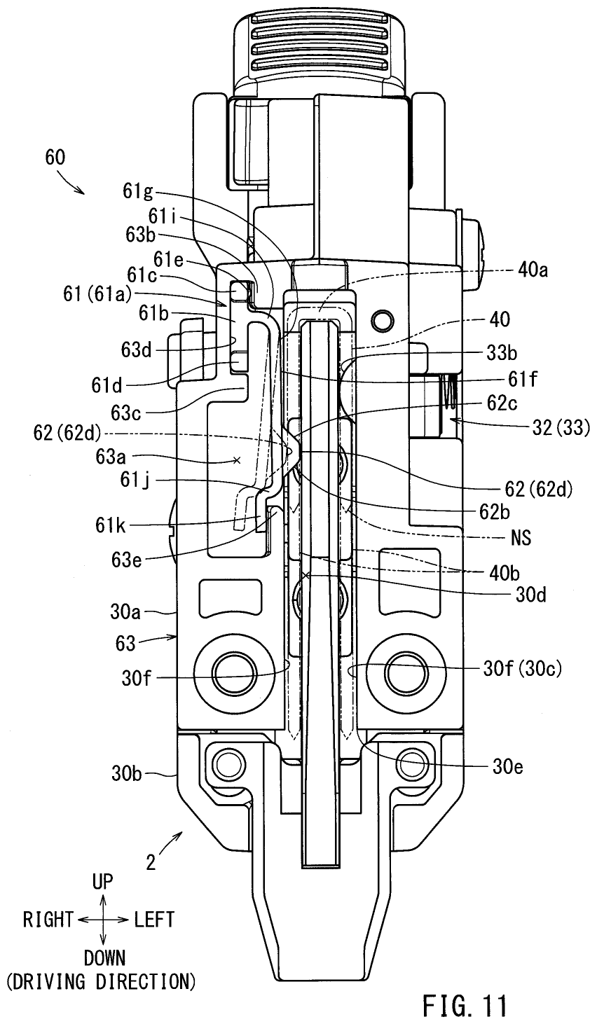

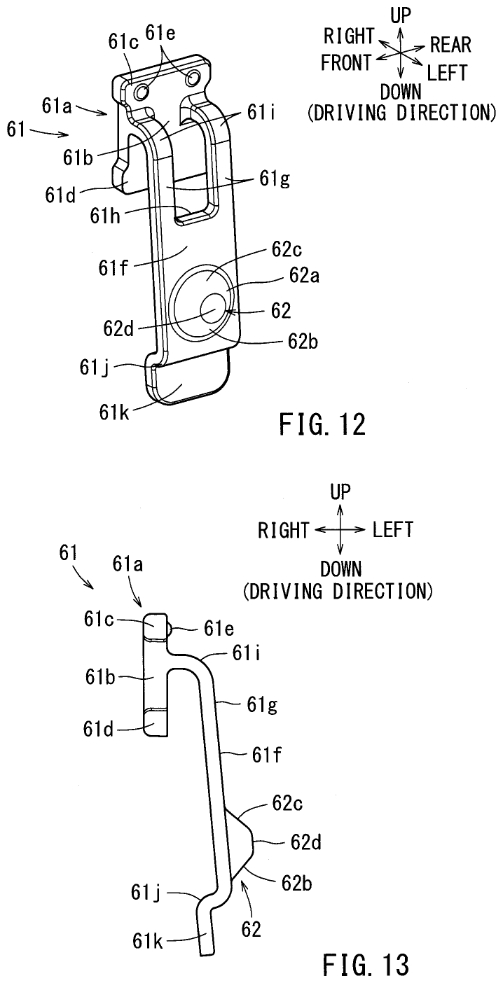

Hereinafter, a third example of the present disclosure will be described with reference to FIGS. 11 to 14. The driving tool 60 of the third example has a resistance-applying member (elastic member) 61 shown in FIG. 12 instead of the resistance-applying member 35 of the driving tool 1 shown in FIG. 4. Instead of the magazine 30 shown in FIG. 1, the driving tool 60 has a magazine 63 shown in FIG. 11, which has a structure to hold the resistance-applying member 61 retractably from the driven member housing section 30d. In the following description, only the parts that differ from the first example will be described in detail.

As shown in FIG. 11, the magazine 63 has a magazine body 30a, a cover 30b, a supply port 30c, a driven member housing section 30d, an opening 30e, and side walls 30f, similar to the magazine 30 (see FIGS. 4 and 8). The magazine 63 has a housing chamber 63a configured to accommodate and hold the resistance-applying member 61. The housing chamber 63a is provided at the front part of the magazine body 30a near the supply port 30c and on the right side of the driven member housing section 30d. Therefore, the resistance-applying member 61 is provided on the opposite left/right side from the blank drive preventing mechanism 32, which is provided on the left side of the driven member housing section 30d.

As shown in FIG. 11, the left end of the housing chamber 63a is open to the driven member housing section 30d. The top of the housing chamber 63a is provided with ribs 63b, 63c and a plane 63d. The rib 63b forms an upper edge of an opening of housing chamber 63a and extends to the right. The plane 63d is located on the right side of the rib 63b and extends flat in the up-down direction and the front-rear direction. The rib 63c projects from the lower end of the plane 63d to the left of the plane 63d. The ribs 63b, 63c and the plane 63d form a rectangular groove together that is long in the up-down direction with a narrow left-right width. A base 61b of the resistance-applying member 61, which will be described below, is press-fitted into this rectangular groove.

As shown in FIG. 11, a ribbed supporting portion 63e is provided at a bottom of the housing chamber 63a. The supporting portion 63e forms a lower edge of the opening of the housing chamber 63a and extends in a flat shape in the up-down direction and the front-rear direction. In an area between the rib 63c and the supporting portion 63e of the housing chamber 63a, a space is provided to allow a deflection portion 61f (described later) of the resistance-applying member 61 to bend to the right.

As shown in FIGS. 11 to 14, the resistance-applying member 61 has a holding part 61a that is held in the magazine 63 and a contacting part 62 that protrudes from the holding part 61a to the left. The contacting part 62 contacts a right side of a right leg 40b of a driven member 40. The holding part 61a has a rectangular flat-shaped base 61b and a deflection portion 61f extending from the base 61b toward left and downward. The contacting part 62 protrudes to left from an intermediate position in the up-down direction of the deflection portion 61f. The base 61b, the deflection portion 61f, and the contacting part 62 are integrally molded from the same material. The material of the resistance-applying member 61 is, for example, synthetic resin.

As shown in FIGS. 11 to 14, the deflection portion 61f extends from the substantial center of the base 61b in the up-down direction to left. The base 61b has a first projecting portion 61c that extends above a connecting portion with the deflection portion 61f and a second projecting portion 61d that extends below the connecting portion with the deflection portion 61f. The first projecting portions 61c and the second projecting portions 61d are slightly longer than the deflection portion 61f to both the front and rear sides. Therefore, the deflection portion 61f has a gap in the front-rear direction relative to the both front-rear ends of the housing chamber 63a when the base 61b is attached to the magazine 63. This gap prevents the deflection portion 61f from interfering with an inner wall of the magazine 63, for example, when the contacting portion 62 is pushed by a lateral face of the leg portion 40b of the driven member 40 and deflects slightly in the front-rear direction.

As shown in FIGS. 11 to 14, a left side of the first projecting portion 61c is provided with two hemispherical front and rear bosses 61e, protruding to left. The first projecting portion 61c is press-fitted between the rib 63b and the plane 63d. The first projecting portion 61c is press-fitted between the ribs 63b and the plane 63d so as not to be removed from the ribs 63b and the plane 63d by providing the bosses 61e. The second projecting portion 61d follows the plane 63d and contacts an upper surface of the rib 63c at a lower end. Thus, the base 61b is held in the groove defined by the ribs 63b, 63c and the plane 63d together.

As shown in FIGS. 11 to 14, the deflection portion 61f has a bent portion 61i that is bent downward from the connecting portion with the base 61b. The deflection portion 61f extends substantially straight from a side closer to an end (lower side) than the bent portion 61i to a point where the contacting part 62 is provided. The deflection portion 61f extends downwardly while being slightly inclined to left away from the base 61b in a natural state where it is not subjected to external force. The deflection portion 61f is inclined at an angle to an extending direction of the base 61b in the natural state. The deflection portion 61f deflects to right when attached to the magazine 63, and extends straight in the up-down direction so as to be substantially parallel to the base 61b. In other words, the deflection portion 61f attached to the magazine 63 is constantly subjected to a biasing force to left due to its elastic deformation from the inclined position in the natural state to the state extending straight in the up-down direction.

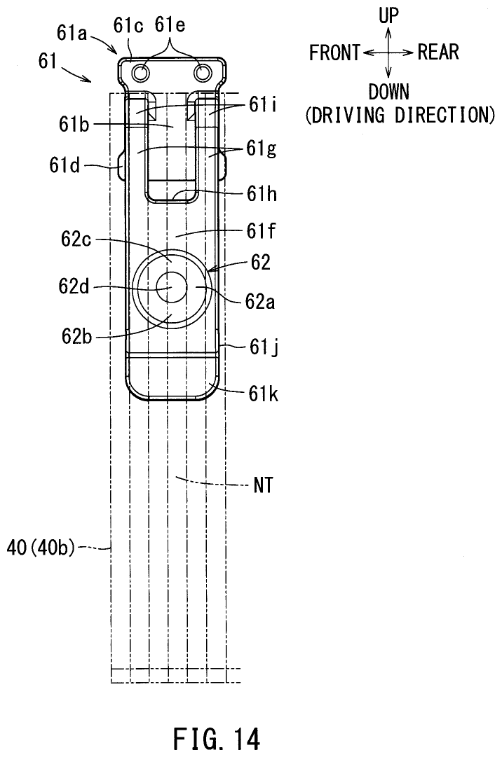

As shown in FIGS. 12 and 14, the deflection portion 61f has a pair of front and rear legs 61g extending parallel to each other from the connecting portion with the base 61b. The pair of legs 61g are provided at both front and rear ends of the deflection portion 61f, respectively. The deflection portion 61f is thus prevented from twisting in the front-rear direction. For example, when the driven members 40 are delivered to the forward driving channel 3 (FIG. 4), the contacting part 62, which is in contact with the driven member(s) 40, is pushed forward. The deflection portion 61f is prevented from being twisted against the force of the contacting part 62 being pushed forward by providing the pair of legs 61g. Between the pair of legs 61g in the forward and rearward directions, a punched portion 61h is provided. A pushing load of the deflection portion 61f is weakened to an extent capable of preventing the driven members 40 from collapsing and not to interfere the feeding operation of the driven members 40 into the driving channel 3 by providing the punched portion 61h.

As shown in FIGS. 11 to 14, a lower part of the deflection portion 61f is provided with an end bending portion 61j that curves in an S-shape toward right. The deflection portion 61f has an end 61k extending in a flat-plate shape below the end bending portion 61j. The end 61k extends substantially parallel to the center of the deflection portion 61f in the up-down direction. The left side of the end 61k contacts a right side of the supporting portion 63e of the magazine 63. As a result, the deflection portion 61f is attached to the magazine 63 with a position extending straight in the up-down direction. Moreover, the deflection portion 61f is restricted from shifting to the driven member housing section 30d to left from the attached position. The deflection portion 61f is only allowed to deflect to right from the attached position within the housing chamber 63a.

As shown in FIGS. 11 to 14, the contacting part 62 is provided in a hemispherical shape that includes a flat portion at a left end. A flat contacting surface 62d is provided at the left end of contacting part 62 that extends parallel to the deflection portion 61f. The flat contacting surface 62d is substantially circular when viewed from left. A spherical surface around the flat contacting surface 62d of the contacting part 62 includes a feed-side curved surface 62a, a loading-side curved surface 62b, and an unloading-side curved surface 62c. The feed-side curved surface 62a is located behind the flat contacting surface 62d and is located upstream of the contacting part 62 where the pusher 31 (see FIG. 4) biases the driven members 40. The loading-side curved surface 62b is located below the contacting surface 62d, which is a side where the driven members 40 are loaded into the driven member housing section 30d. The unloading-side curved surface 62c is located above the contacting surface 62d, which is a side where the driven members 40 are unloaded from the driven member housing section 30d.

As shown in FIGS. 11 and 14, the flat contacting surface 62d of the contacting part 62 contacts a right side of the leg 40b of the driven member NT in a surface contact manner. The flat contacting surface 62d is restricted from entering a gap between the front/rear aligned driven members 40 by the surface contact. This prevents the contacting part 62 from being caught to the driven member 40, thereby allowing the driven members 40 to be smoothly fed into the driving channel 3 (FIG. 4). The deflection portion 61f can be deflected to right to allow the contacting part 62 to be retracted from the driven member housing section 30d, as indicated by a virtual line in FIG. 11. This also prevents the contacting part 62 from being caught to the driven member 40, and the feeding operation of the driven members 40 may be smoothly performed.

As described above, the resistance-applying member 61 has a contacting part 62 that contacts the driven member 40 as shown in FIGS. 11 and 14. The contacting part 62 includes a flat contacting surface 62d that contacts a side of the driven member 40 in a surface contact manner. Thus, the flat contacting surface 62d comes in contact with the side of the driven member(s) 40 in the surface contact manner. The flat contacting surface 62d is larger than the groove between driven members 40 aligned in parallel. This prevents the contacting part 62 from entering the groove between the driven members 40. Therefore, the feeding operation of the driven members 40 by the pusher 31 (see FIG. 4) may be smoothly performed.

As shown in FIG. 11, the resistance-applying member 61 has a holding part 61a that is held in the magazine 63. The resistance-applying member 61 has a deflection portion 61f that extends from the base 61b of the holding part 61a and is elastically deformable. The resistance-applying member 61 has a contacting part 62 protruding from the deflection portion 61f and contacting the driven member 40. The magazine 63 has a supporting portion 63e that supports the end 61k of the deflected deflection portion 61f with the end 61k being in contact and with the deflection portion 61f. Therefore, the contacting part 62 is always biased in a direction opposite to the deflecting direction of the deflection portion 61f. Furthermore, the deflection portion 61f can be retracted in a direction away from the driven members 40 by being deflected. Therefore, the contacting part 62 can always bias the driven members 40 with a pushing load to the extent that the driven members 40 do not collapse within the magazine 63 and are smoothly fed into the driving channel 3 (FIG. 4). The deflection portion 61f is restricted from protruding toward the driven members 40 by the supporting portion 63e. Therefore, the feeding operation of the driven members 40 by the pusher 31 (FIG. 4) may be performed smoothly.

Various modifications may be made to the driving tools 1, 50, and 60 in each of the examples described above. The gas-spring type driving tools 1, 50, 60 were exemplary described in the examples. Instead, the present disclosure may be applied to a driving tool that is referred to as a mechanical spring type, for example, where a driver is moved in a counter-driving direction by a lift mechanism to increase a spring force of a mechanical compression spring or the like, thereby moving the driver in a driving direction. The shape, size, and others, of the driven member shall not be limited to the exemplary described driven member 40 but may be modified as needed.

The driver 15 shall not be limited to the one described in the example but may be modified as needed. For example, the number of rack teeth 15b and the interval in the up-down direction may be changed appropriately. The lift mechanism 22 shall not be limited to the one described in the example but may be changed as needed. For example, the number of engaging portions 24 and the circumferential interval may be changed as needed. For example, instead of pin-shaped engaging portions 24, engaging portions may be in a pinion-shape with a plurality of teeth.

A configuration has been described in examples in which both the resistance-applying member 35 and the stopper 33 are arranged on left side of the driven member housing section 30d. Alternatively, both the resistance-applying member 35 and the stopper 33 may be arranged on right side of the driven member housing section 30d. Although the compactness of the driving tool 1 may be impaired, the resistance-applying member 35 and the stopper 33 may be arranged on opposite left and right sides of the driven member housing section 30d, respectively. The driven member NT that the contacting parts 35b, 51b of the resistance-applying members 35, 51 contact is not limited to the third from the front side as described in the example, but may be the second or earlier, or even the fourth or later.

The resistance-applying members 35, 51 made of rubber or metal have been described in the example. Alternatively, the resistance-applying members may be spring members made of, for example, a resin material. A configuration in which the holding parts 35a, 51a and the contacting parts 35b, 51b of the resistance-applying members 35, 51 are formed in one piece of the same material has been described in the examples; however, they may be made of different materials, for example, only the contacting parts 35b, 51b may be made of elastic members. The contacting parts 35b, 51b may be formed in a flat shape which does not protrude from the holding parts 35a, 51a. The end (right end) of the contacting parts 35b, 51b may be formed in a flat shape that follows the side of the leg 40b of the driven member 40 instead of a curved surface.

The resistance-applying members 35 and 51, which apply resistance to the driven member 40 by the elastic members, have been described in the examples. Instead, for example, a magnet may be provided on the left and right sides of the base 40a of the driven member 40 to attract the base 40a with the magnetic force of the magnet to apply resistance to the driven member 40.

A deflection portion 61f extending downward from the base 61b has been described in the example. Alternatively, the deflection portion 61f may be configured to extend, for example, upward, rearward, or forward from the base 61b. A configuration in which the deflection portion 61f extends from the substantial center of the base 61b in the up-down direction has been described in an example. Alternatively, the deflection portion 61f may extend, for example, from the upper or lower end of the base 61b. The structure for holding the base 61b in the magazine 63 may be changed appropriately. For example, a boss 61e may be provided on the second projecting portion 61d alternatively or additionally to the first projecting portion 61c. For example, the shape of the ribs, etc. of the housing chamber 63a may be changed to match the shape of the base 61b. A point, such as a flat contacting surface 62d of the contacting part 62, where to contact the driven member in a surface contact manner, may be provided at the contacting part 35b, 51b.

What is claimed is:

1. A driving tool comprising:
a tool body having a driving channel;
a magazine attached to the tool body;
a pusher configured to bias a plurality of driven members within the magazine toward the driving channel;
a driver configured to drive one of the plurality of driven members being loaded into the driving channel;
a blank drive preventing mechanism configured to restrict a driving operation of the driver when a number of the plurality of driven members in the magazine is less than or equal to a predetermined number, and
a resistance-applying member configured to maintain an orientation of a remaining of the plurality of driven members by applying resistance to the remaining of the plurality of driven members in the magazine when the blank drive preventing mechanism operates, wherein
the resistance-applying member is provided at a location corresponding to a shortest available driven member.

2. The driving tool according to claim 1, wherein the resistance-applying member has an elastic member configured to bias the remaining of the plurality of driven members via elastic force.

3. The driving tool according to claim 2, wherein the elastic member is made of rubber.

4. The driving tool according to claim 1, wherein the resistance-applying member has a contacting part to contact at least one of the plurality of driven members, and
wherein the contacting part includes a loading-side curved surface in a loading direction of the plurality of driven members into the magazine.

5. The driving tool according to claim 4, wherein the contacting part includes a feed-side curved surface in a biasing direction of the pusher.

6. The driving tool according to claim 4, wherein the contacting part further includes an unloading-side curved surface in an unloading direction of the plurality of the driven members from the magazine.

7. The driving tool according to claim 1, wherein the resistance-applying member has a contacting part to contact the plurality of the driven members, and
wherein the contacting part includes a flat contacting surface to contact a side of the plurality of driven members in a surface contact manner.

8. The driving tool according to claim 1, wherein the magazine has an opening through which the plurality of driven members are loaded from downstream to upstream in a driving direction of the plurality of driven members.

9. The driving tool according to claim 1, wherein the blank drive preventing mechanism includes a detection member that is biased toward the pusher and removed from the pusher when a number of the plurality of driven members in the magazine is about less than or equal to the predetermined number, and
wherein the resistance-applying member is configured to bias the plurality of driven members in a direction parallel to a biasing direction of the detection member.

10. The driving tool according to claim 1, wherein the blank drive preventing mechanism includes a detection member that is biased toward the pusher and removed from the pusher when a number of the plurality of driven members in the magazine is about less than or equal to the predetermined number, and
wherein the detection member and the resistance-applying member are positioned on the same side within the magazine.

11. The driving tool according to claim 1, wherein the resistance-applying member further includes a holding part being held in the magazine and a contacting part being provided integrally with the holding part.

12. The driving tool according to claim 11, wherein the contacting part is configured to protrude from the holding part and contact the plurality of driving members.

13. The driving tool according to claim 1, wherein the resistance-applying member includes a holding part being held in the magazine, a deflection portion being elastically deformable and extending from the holding part, and a contacting part protruding from the deflection portion and contacting the plurality of driven members, and
wherein the magazine has a supporting portion configured to support the deflection portion with an end of the deflection portion contacting and the deflection portion being bent.

14. The driving tool according to claim 1, wherein the plurality of driven members is a staple type having a base that is struck by the driver and a pair of legs that extends substantially parallel from both ends of the base.

15. A driving tool comprising:
a tool body having a driving nose arranged at a lower part of the tool body, wherein the driving nose has a driving channel;
a magazine coupled to the driving nose and attached to the tool body, wherein the magazine has a groove-shaped driving member housing section for housing a plurality of driven members;
a pusher having a right-left flat plates extending in an up-down direction and a front-rear direction, wherein the pusher is configured to bias the plurality of driven members in the magazine toward the driving channel;
a driver that is a front rear two-stated structure having a striking portion, wherein a lower part of the striking portion is configured to drive one of the plurality of driven members into the driving channel;
a blank drive preventing mechanism configured to restrict a driving operation of the driver when a number of the plurality of driven members in the magazine is less than or equal to a predetermined number, and
a resistance-applying member having an elastic member configured to elastically bias the plurality of driven members remaining in the magazine for stable orientation.

16. The driving tool according to claim 15, wherein the driving nose has a contact arm that is slidable in the up-down direction, and wherein the contact arm is configured to bias toward a lower off position.

17. The driving tool according to claim 15 further has a wheel configured to rotate and to lift the driver.

18. The driving tool according to claim 15, wherein the blank drive preventing mechanism has a stopper configured to restrict the contract arm from moving upward, and wherein the stopper is rotatable around a rotary shaft in a left-right direction.

19. The driving tool according to claim 18, wherein the stopper further has
an engaging portion positioned at a front end of the stopper for restricting the contact arm from moving upward to an on position, and
a contacting part protruding to a right behind the rotary shaft for entering into the driven member housing section.

20. The driving according to claim 18 further has a compression spring arranged behind the rotary shaft and on a left side of the contacting part, wherein the compression spring is configured to bias the stopper to rotate in a clockwise direction.
